(19) United States
(12) Patent Application Publication
(10) Pub. No.: US 2017/0289054 A1
(43) Pub. Date: Oct. 5, 2017

(54) APPARATUS AND METHOD TO DETERMINE A TYPE OF CONGESTION CONTROL BASED ON TEMPORAL CHANGE IN A WINDOW SIZE

(71) Applicant: FUJITSU LIMITED, Kawasaki-shi (JP)

(72) Inventors: NAOYOSHI OHKAWA, Kawasaki (JP); Yuji NOMURA, Kawasaki (JP); Fumiyuki Iizuka, Kawasaki (JP); SUMIYO OKADA, Kawasaki (JP); Hirokazu Iwakura, Adachi (JP)

(73) Assignee: FUJITSU LIMITED, Kawasaki-shi (JP)

(21) Appl. No.: 15/455,267

(22) Filed: Mar. 10, 2017

(30) Foreign Application Priority Data
Mar. 30, 2016 (JP) 2016-069209

(51) Int. Cl. H04L 12/841; H04L 12/26; H04L 12/801; H04L 12/807

(52) U.S. Cl. CPC H04L 47/28; H04L 47/27; H04L 43/0841; H04L 47/11; H04L 43/0888

(57) ABSTRACT

An apparatus acquires time-series information that stores information on a packet transmitted and received between a first apparatus and a second apparatus in association with a time at which the packet is transmitted or received. The apparatus estimates a window size indicating an amount of data that a receiver of the data is able to accept without acknowledging a sender of the data, based on the acquired time-series information, and, based on temporal change in the estimated window size, determines a type of congestion control being executed by the first apparatus, from among a plurality of candidate types of congestion control.

### CROSS-REFERENCE TO RELATED APPLICATION

This application is based upon and claims the benefit of priority of the prior Japanese Patent Application No. 2016-069209, filed on Mar. 30, 2016, the entire contents of which are incorporated herein by reference.

### FIELD

The embodiments discussed herein are related to apparatus and method to determine a type of congestion control based on temporal change in a window size.

### BACKGROUND

A technique has been disclosed which allows a communication bandwidth of a line not to being occupied by communication using a not-normal transmission control protocol (TCP) that allows it to achieve a high throughput even when a competition occurs with communication using a normal TCP (see, for example, Japanese Laid-open Patent Publication No. 2007-11702).

### SUMMARY

According to an aspect of the invention, an apparatus acquires time-series information that stores information on a packet transmitted and received between a first apparatus and a second apparatus, in association with a time at which the packet is transmitted or received. The apparatus estimates a window size indicating an amount of data that a receiver of the data is able to accept without acknowledging a sender of the data, based on the acquired time-series information, and, based on temporal change in the estimated window size, determines a type of congestion control being executed by the first apparatus, from among a plurality of candidate types of congestion control.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an outline of an information processing system, according to an embodiment;

FIG. 2 is a diagram illustrating an example of a hardware configuration of a computer, according to an embodiment;

FIG. 3 is a diagram illustrating an example of a hardware configuration of a sever computer, according to an embodiment;

FIG. 4 is a diagram illustrating an example of a hardware configuration of a monitoring computer, according to an embodiment;

FIG. 5 is a diagram illustrating an example of a record layout of a reception time table, according to an embodiment;

FIG. 6 is a diagram illustrating an example of a flow of a three-way handshaking process, according to an embodiment;

FIG. 7 is a diagram illustrating an example of a record layout of a data information table, according to an embodiment;

FIG. 8 is a diagram illustrating an example of a record layout of an ACK information table, according to an embodiment;

FIG. 9 is a diagram illustrating an example of a status in terms of transmission and reception of packets, according to an embodiment;

FIG. 10 is a diagram illustrating an example of a record layout of an analysis information table, according to an embodiment;

FIG. 11 is a diagram illustrating an example of an operational flowchart for a three-way handshaking process, according to an embodiment;

FIG. 12 is a diagram illustrating an example of an operational flowchart for a measurement process, according to an embodiment;

FIG. 13 is a diagram illustrating an example of an operational flowchart for a measurement process, according to an embodiment;

FIG. 14 is a diagram illustrating an example of an operational flowchart for a process performed when ACK is received, according to an embodiment;

FIG. 15 is a diagram illustrating an example of an operational flowchart for a process performed when ACK is received, according to an embodiment;

FIG. 16 is a diagram illustrating an example of an operational flowchart for a process performed when a packet loss occurs, according to an embodiment;

FIG. 17 is a diagram illustrating an example of an operational flowchart for a process of determining a type of congestion control, according to an embodiment;

FIG. 18 is a diagram illustrating an example of an operational flowchart for a process of determining a type of congestion control, according to an embodiment;

FIG. 19 is a diagram illustrating an example of an operational flowchart for a process of outputting cause information, according to an embodiment;

FIG. 20 is a diagram illustrating an example of an operational flowchart for a process of outputting cause information, according to an embodiment;

FIG. 21 is a diagram illustrating an example of a status in terms of transmission and reception of data, according to an embodiment;

FIG. 22 is a diagram illustrating an example of a status in terms of transmission and reception of data, according to an embodiment;

FIG. 23 is a diagram illustrating an example of a status in terms of transmission and reception of data, according to an embodiment;

FIG. 24 is a diagram illustrating an example of a status in terms of transmission and reception of data, according to an embodiment;

FIG. 25 is a diagram illustrating an example of a status in terms of transmission and reception of data, according to an embodiment;

FIG. 26 is diagram illustrating an example of an operation of a monitoring computer, according to an embodiment; and

FIG. 27 is a diagram illustrating an example of a hardware configuration of a monitoring computer, according to an embodiment.

### DESCRIPTION OF EMBODIMENTS

The related technique has a problem that it is difficult to recognize what congestion control is being performed at a receiving apparatus.

It is preferable to identify a congestion control being performed at a receiving apparatus.

### First Embodiment

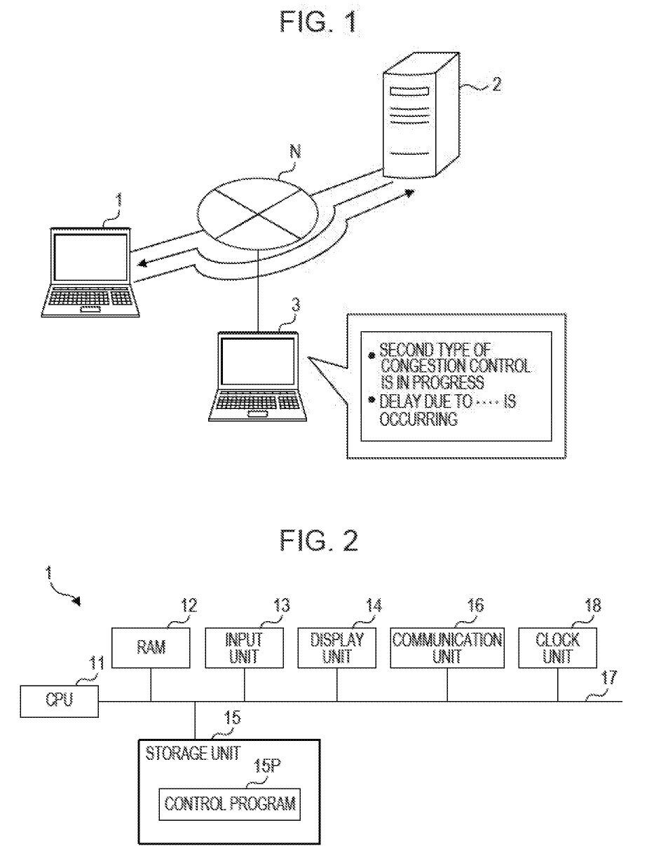

Embodiments are described below with reference to drawings. FIG. 1 is a diagram illustrating an outline of an information processing system. The information processing system includes a first information processing apparatus (first apparatus) 1, a second information processing apparatus (second apparatus) 2, and a third information processing apparatus 3, and the like. Each of these information processing apparatuses may be a personal computer, a sever computer, a smartphone, a portable telephone, a personal digital assistant (PDA), or the like. In the following description, it is assumed by way of example that the first information processing apparatus 1 is a computer 1, the second information processing apparatus is a sever computer 2, and the third information processing apparatus 3 is a monitoring computer 3. The computer 1, the sever computer 2 and the monitoring computer 3 are coupled to each other via a communication network N such as the Internet, a local area network (LAN), or a public network.

The monitoring computer 3 acquires a packet that is transmitted and received between the computer 1 and the sever computer 2. The monitoring computer 3 analyzes the acquired packet by performing a process described later. After the analysis, the monitoring computer 3 displays, on the display unit, a type of congestion control determined as being performed by the computer 1, and also displays a cause of an occurrence of a delay. A further detailed description is given below.

FIG. 2 is a block diagram illustrating a set of hardware of the computer 1. The computer 1 includes a central processing unit (CPU) 11 serving as a control unit, a random access memory (RAM) 12, an input unit 13, a display unit 14, a storage unit 15, a clock unit 18, a communication unit 16, and the like. The CPU 11 is coupled to each hardware part via a bus 17. The CPU 11 controls each hardware part according to a control program 15P stored in the storage unit 15. The RAM 12 may be, for example, a static RAM (SRAM), a dynamic RAM (DRAM), a flash memory, or the like. The RAM 12 also functions as a storage unit for use by the CPU 11 to temporarily store various kinds of data during execution of various programs.

The input unit 13 is an input device such as a touch panel, or a button. When an operation is performed on the input unit 13, information on the operation is output to the CPU 11. The display unit 14 may be a liquid crystal display, an organic EL (electroluminescence) display, or the like, and the display unit 14 is configured to display various kinds of information under the control of the CPU 11. The communication unit 16 is a communication module configured to transmit and receive information to and from the sever computer 2 or the like. The clock unit 18 outputs date-and-time information to the CPU 11. The storage unit 15 is a large-capacity memory for use to store the control program 15P or the like.

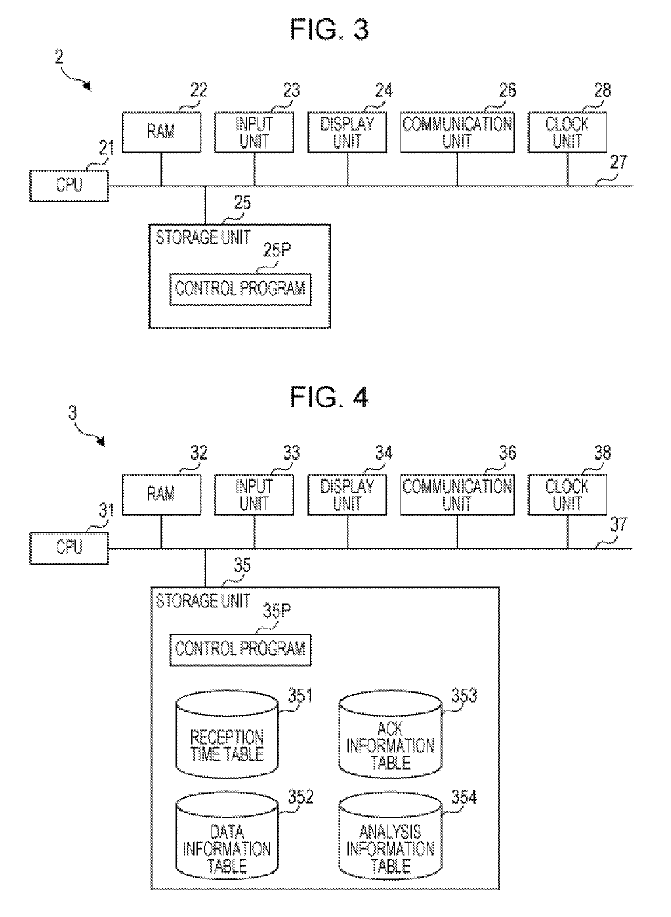

FIG. 3 is a block diagram illustrating a set of hardware of the sever computer 2. The sever computer 2 includes a CPU 21 serving as a control unit, a RAM 22, an input unit 23, a display unit 24, a storage unit 25, a clock unit 28, a communication unit 26, and the like. The CPU 21 is coupled to each hardware part via a bus 27. The CPU 21 controls each hardware part according to a control program 25P stored in the storage unit 25. The RAM 22 may be, for example, an SRAM, a DRAM, a flash memory, or the like. The RAM 22 also functions as a storage unit for use by the CPU 21 to temporarily store various kinds of data during execution of various programs.

The input unit 23 is an input device such as a keyboard, or a button. When an operation is performed on the input unit 23, information on the operation is output to the CPU 21. The display unit 24 may be a liquid crystal display, an organic EL display, or the like, and the display unit 24 is configured to display various kinds of information under the control of the CPU 21. The communication unit 26 is a communication module configured to transmit and receive information to and from the computer 1 or the like. The clock unit 28 outputs date-and-time information to the CPU 21. The storage unit 25 is a hard disk or a large-capacity memory for use to store the control program 25P or the like.

FIG. 4 is a diagram illustrating a set of hardware of the monitoring computer 3. The monitoring computer 3 includes a CPU 31 functioning as a control unit, a RAM 32, an input unit 33, a display unit 34, a storage unit 35, a clock unit 38, a communication unit 36, and the like. The CPU 31 is coupled to each hardware part via a bus 37. The CPU 31 controls each hardware part according to a control program 35P stored in the storage unit 35. The RAM 32 may be, for example, an SRAM, a DRAM, a flash memory, or the like. The RAM 32 also functions as a storage unit for use by the CPU 31 to temporarily store various kinds of data during execution of various programs.

The input unit 33 is an input device such as a keyboard, or a mouse. When an operation is performed on the input unit 33, information on the operation is output to the CPU 31. The display 34 may be a liquid crystal display, an organic EL display, or the like, and the display unit 34 is configured to display various kinds of information under the control of the CPU 31. The communication unit 36 is a communication module configured to transmit and receive information to and from the computer 2, the sever computer 1, and the like. The clock unit 38 outputs date-and-time information to the CPU 31.

The storage unit 35 may be a hard disk or a large-capacity memory, and the storage unit 35 includes a control program 35P, a reception time table 351, a data information table 352, an ACK information table 353, an analysis information table 354, and the like. In the embodiment, it is assumed by way of example that the reception time table 351 and other tables are stored in the storage unit 35. However, the tables may be stored in another storage space. For example, the tables may be stored in another DB server.

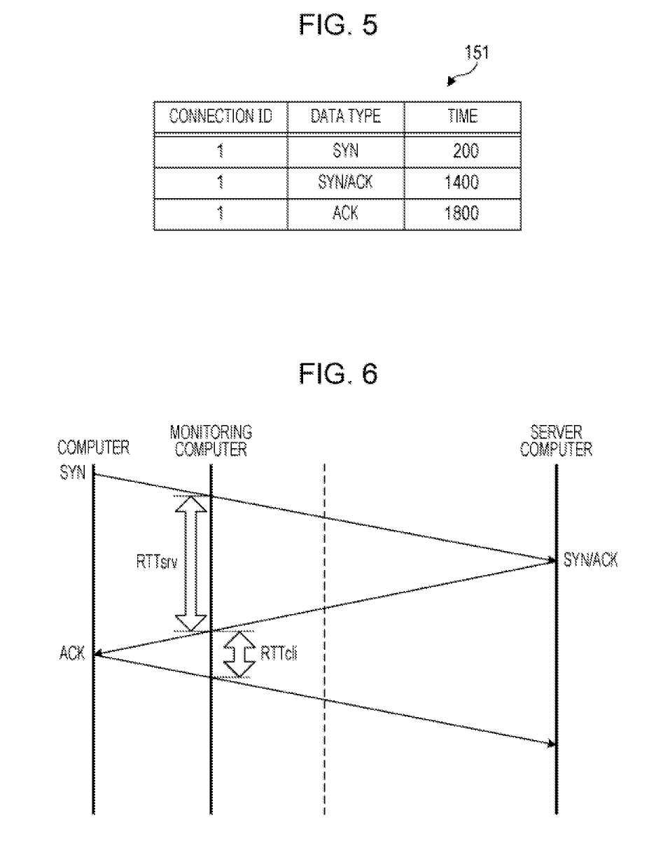

FIG. 5 is a diagram illustrating a record layout of the reception time table 351. The reception time table 351 includes a connection ID field, a data type field, a time field, and the like. The connection ID field stores identification information identifying a connection of a communication between the sever computer 2 and the computer 1 (hereinafter, this identification information will be referred to as a connection ID). The data type field stores, in relation to the connection ID, a data type of a packet transmitted or received in a three-way handshaking process. More specifically, the data type may be one of following three data types: SYN (Synchronize); ACK (Acknowledge); and SYN/ACK. The time field stores, in relation to the connection ID and the data type, a time at which the monitoring computer 3 receives a packet.

FIG. 6 is a diagram illustrating a flow of a three-way handshaking process. First, the CPU 31 of the monitoring computer 3 receives SYN from the computer 1. The CPU 31 stores SYN as the data type in the reception time table 351. Furthermore, the CPU 31 stores 200 as the reception time of SYN in the reception time table 351. In a case where SYN is received, the CPU 31 stores a maximum transmission unit (MTU) in the storage unit 35. In the embodiment, it is assumed by way of example that the MTU is 1500. Next, the CPU 31 receives SYN/ACK transmitted from the sever computer 2. The CPU 31 stores SYN/ACK as the data type in the reception time table 351, and stores 1400 as the reception time for SYN/ACK in the reception time table 351.

Finally, the CPU 31 receives ACK transmitted from the computer 1. The CPU 31 stores ACK as the data type in the reception time table 351, and stores 1800 as the reception time for ACK in the reception time table 351. The CPU 31 calculates an estimated round trip time on the side of the sever computer 2 (hereinafter, this round trip time will be referred to as RTTsrv). More specifically, the CPU 31 subtracts 200 indicating time of SYN from 1400 indicating time of SYN/ACK, and thus the CPU 31 obtains 1200 as RTTsrv. Furthermore, the CPU 31 calculates an estimated round trip time on the side of the computer 1 (hereinafter, this round trip time will be referred to as RTTcli). More specifically, the CPU 31 subtracts 1400 indicating the reception time for SYN/ACK from 1800 indicating reception time for ACK, and thus the CPU 31 obtains 400 as RTTcli.

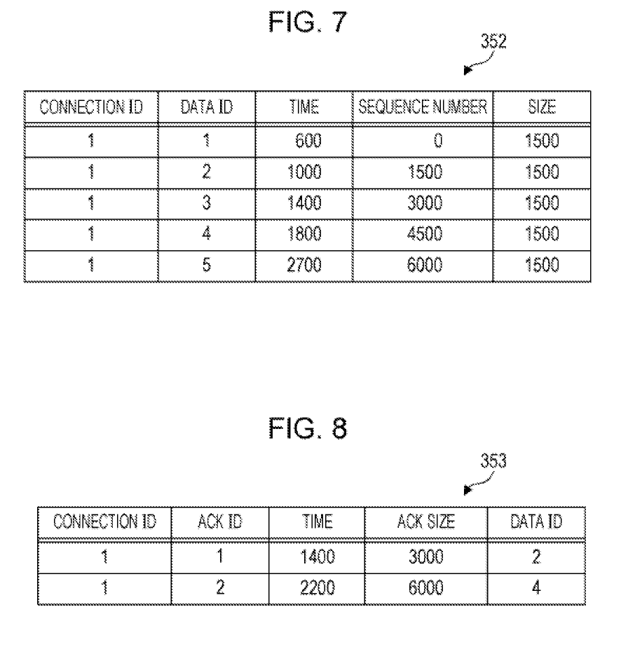

FIG. 7 is a diagram illustrating a record layout of the data information table 352. The data information table 352 includes a connection ID field, a data ID field, a time field, a sequence number field, a size field, and the like. The data ID field stores, in relation to a connection ID, identification information identifying packet data transmitted from the sever computer 2 (hereinafter, this identification information will be referred to as a data ID). The time field stores, in relation to the data ID, a time when a packet is received. The sequence number field stores, in relation to a data ID, a first value of sequence numbers (hereinafter referred to as Seq) of a received packet. The size field stores, in relation to a data ID, a size of a received packet.

FIG. 8 is a diagram illustrating a record layout of the ACK information table 353. The ACK information table 353 includes a connection ID field, an ACK ID field, a time field, ACK size field, a data ID field, and the like. The ACK ID field stores, in relation to a connection ID, identification information identifying ACK information transmitted from the computer 1 (hereinafter, this identification information will be referred to as an ACK ID). The time field stores, in relation to an ACK ID, a time when ACK information is received. The data ID field stores, in relation to an ACK ID, a data ID associated with data as of before ACK information is received.

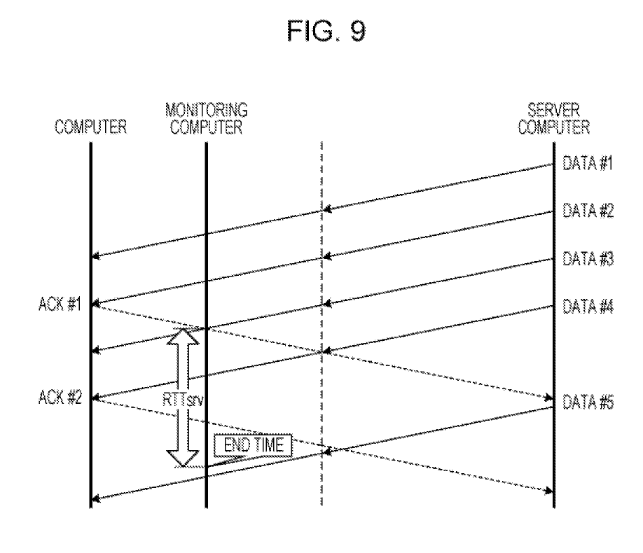

FIG. 9 is a diagram illustrating a status in terms of transmission and reception of packets. The CPU 31 receives data #1 to data #5 from the sever computer 2. For example, when data #3 is received, the CPU 31 stores, in relation to a connection ID of 1, 3 as the data ID in the data information table 352. Furthermore, the CPU 31 stores 1400 as a data reception time for the data #3. The CPU 31 stores, in relation to a data ID, 3000 as a sequence number and 1500 as a data size in the data information table 352.

In a case where ACK is received, the CPU 31 stores, in relation to the connection ID, an ACK ID in the ACK information table 353. For example, in a case where an ACK #1 is received, the CPU 31 stores 1 as the ACK ID in relation to the connection ID of 1. Furthermore, the CPU 31 stores, in the ACK information table 353, a time at which ACK is received. The CPU 31 adds 1500 indicating the data size to 1500 indicating the sequence number, and stores a result of the addition, that is, 3000, as the ACK size in the ACK information table 353. Based on the determination that the ACK size is 3000, the CPU 31 checks the data information table 352 and determines that 2 is the data ID corresponding to the ACK transmission, and thus the CPU 31 stores the data ID of 2 in relation to ACK ID of 1 in the ACK information table 353. For second ACK, 2 is assigned as the ACK ID, and its reception time and ACK size are respectively 2200 and 6000 (=4500 indicating the sequence number+1500 indicating the size), and 4 is determined to be the data ID corresponding to the second ACK.

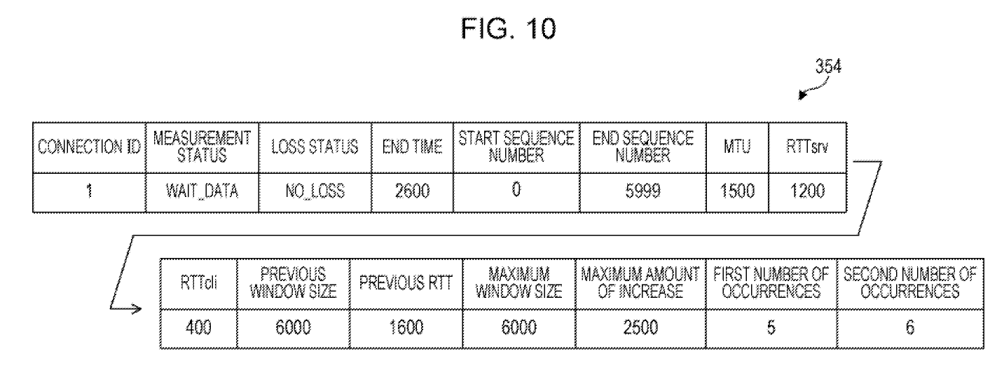

FIG. 10 is a diagram illustrating a record layout of the analysis information table 354. The analysis information table 354 includes a connection ID field, a measurement status field, a loss status field, an end time field, a start sequence number field, an end sequence number field, an MTU field, and an RTTsrv field. The analysis information table 354 further includes an RTTcli field, a previous window size field, a previous RTT field, a maximum window size field, a maximum amount of increase field, a first number of times field, a second number of times field, and the like. The measurement status field stores, in relation to a connection ID, a status in measurement of a packet transmitted and received between the sever computer 2 and the computer 1. In the embodiment, the measurement status field may take one of two values, that is, WAIT_DATA indicating a data waiting status or WAIT_ACK indicating an ACK waiting status. Although for simplicity of illustration, only one record of the analysis information table 354 is illustrated in the example, actual data changes with time, and a history of data is sequentially stored in the analysis information table 354.

The loss status field stores, in relation to a connection ID, a packet loss status. In the embodiment, the loss status field may take one of three values, that is, NO_LOSS indicating that there is no occurrence of a packet loss, NOW_LOSS indicating an occurrence of a packet loss, and PRE_LOSS indicating that an occurrence of a packet loss was previously determined. The end time field stores a time at which measurement for a measurement group was finished. In the example illustrated in FIG. 10, 2600 is stored. The measurement group refers to a group of packets received during a period from a time at which a first packet is received to an end time which will be described later. The start sequence number field stores a start sequence number of a measurement group. The end sequence number field stores an end sequence number of the measurement group. In the example illustrated in FIG. 10, 0 is stored as the start sequence number of the measurement group, and 5999 is stored as the end sequence number.

The MTU field stores MTU described above. The RTTsrv field stores 1200 as RTTsrv indicating RTT as the side of the sever computer 2. The RTTcli field stores RTTcli indicating RTT as the side of the computer 1. The previous window size field stores an estimated window size. Note that a process of calculating the window size will be described later. The previous RTT field stores RTT having a value equal to the sum of RTTsrv and RTTcli. In the example illustrated in FIG. 10, 1600 (=1200 indicating RTTsrv+400 indicating RTTcl) is stored. The maximum window size field stores a value of a maximum window size among those in the same connection ID.

The maximum amount of increase field stores a value of a maximum amount of increase among the amounts of increase in a current window size from the previous window size. For example, in a case where the previous window size is 3500 and the current window size is 6000, the amount of increase is 2500. The CPU 31 stores a maximum value among the calculated amounts of increase, in the analysis information table 354. The first number of times field stores the number of times that it is determined that the RTT as of immediately after a packet loss occurs in the same connection ID is greater than the RTT (previous RTT) as of immediately before the occurrence of the packet loss. The second number of times field stores the number of times that a packet loss has occurred within the same connection ID.

Referring to FIG. 9, a description is given below as to a process of storing various kinds of information in the data information table 352, the ACK information table 353, and the analysis information table 354. In FIG. 9, when the monitoring computer 3 receives data #1 from the sever computer 2, the CPU 31 stores, in the data information table 352, 1 as the connection ID, 1 as the data ID, 600 as the time, 0 as the sequence number, and 1500 as the size. When the CPU 31 receives, thereafter, data #2, the CPU 31 stores 2 as the data ID, 1000 as the time, 1500 as the sequence number, and 1500 as the size. Note that an initial value of the measurement status is WAIT_ACK. Furthermore, the CPU 31 stores 1500 as MTU and 1200 as RTTsrv acquired via the three-way handshaking in the analysis information table 354.

Next, the monitoring computer 3 receives ACK #1 addressed to the server computer 2 from the computer 1. When ACK #1 is received, the CPU 31 stores 1 as the ACK ID and 1400 as the time in the ACK information table 353. Furthermore, the CPU 31 adds 1500 indicating the size to 1500 indicating sequence number, and stores a resultant sum of 3000 as the ACK size in the ACK information table 353. The CPU 31 then checks the data information table 352 to detect a data ID of data having a sequence number smaller than the value of the ACK size, i.e., 3000. In this specific example, 2 is detected as a data ID. The CPU 31 stores the detected value 2 of the data ID in the ACK information table 353.

After ACK #1 is received, the CPU 31 calculates RTTcli. The CPU 31 subtracts the value of 1000 of the time for the data with the data ID of 2 addressed to the computer 1 from the value of 1400 of the time for ACK with the ACK ID of 1, thereby obtaining 400 as the RTTcli. The CPU 31 stores the calculated value of RTTcli in the analysis information table 354. The CPU 31 performs initial setting for a measurement group. More specifically, the CPU 31 adds the value of 1200 of RTTsrv to the value of 1400 of the time for ACK with the ACK ID of 1, thereby obtaining 2600 as the end time 2600. The CPU 31 stores the resultant value of 2600 of the end time in the analysis information table 354.

The CPU 31 stores, in the analysis information table 354, a start sequence number (0 in the example) of first data appearing after the end sequence number of the previous measurement group. Thereafter, the CPU 31 changes the measurement status to WAIT_DATA. The CPU 31 adds the value of 400 of RTTcli to the value of 1200 of RTTsrv, thereby obtaining a value of 1600 as previous RTT. The CPU 31 stores the resultant value of previous RTT in the analysis information table 354.

Subsequently, when the CPU 31 receives data #3, the CPU 31 stores 3 as the data ID, 1400 as the time, 3000 as the sequence number, and 1500 as the size. When the CPU 31 receives data #4, the CPU 31 stores 4 as the data ID, 1800 as the time, 4500 as the sequence number, and 1500 as the size 1500. In this state, the measurement status is WAIT_DATA, and thus the CPU 31 determines whether the data #3 or the data #4 belong to the same measurement group. Because the end time is 2600, and the time for the data #3 and the end time for the data #4 are respectively 1400 and 1800, the CPU 31 determines that the data #3 and the data #4 belong to the same measurement group.

Next, the CPU 31 receives ACK #2. The CPU 31 stores, in the ACK information table 353, 2 as the ACK ID and 2200 as the time. The CPU 31 adds the value of 1500 of the size to the value 4500 of the sequence number, thereby obtaining 6000 as the ACK size. The CPU 31 stores the resultant value of 6000 of the ACK size in the ACK information table 353. The CPU 31 checks the data information table 352 to detect data having a sequence number smaller than the value of 6000 of the ACK size. In this specific example, 4 is detected as the data ID for such data. The CPU 31 stores the detected value of 4 of the data ID in the ACK information table 353.

After ACK #2 is received, the CPU 31 calculates RTTcli. More specifically, the CPU 31 subtracts the value of 1800 of the time for the data with the data ID of 4 from the value 2200 of the time for ACK with the ACK ID of 2, thereby obtaining 400 as RTTcli. The CPU 31 stores the calculated value of RTTcli in the analysis information table 354. The CPU 31 adds the value of 400 of RTTcli to the value of 1200 of RTTsrv, thereby obtaining 1600 as previous RTT. The CPU 31 stores the calculated value of previous RTT in the analysis information table 354, thereby updating it. In a case where the calculated value of RTT is maximum within the measurement group, the CPU 31 stores the calculated value of RTT as maximum RTT in the RAM 32.

In FIG. 9, finally, the CPU 31 receives data #5. When the data #5 is received, the CPU 31 stores, in the data information table 352, 5 as the data ID, 2700 as the time, 6000 as the sequence number, and 1500 as the size. In this state, the measurement status is WAIT_DATA, and thus the CPU 31 determines whether the data #5 is within the same measurement group. In this case, the value of 2700 of the time for the data #5 is greater than the value of 2600 of the end time, and thus the CPU 31 determines that data #5 belongs to a different measurement group. The CPU 31 measures the window size. The CPU 31 checks the data information table 352 and calculates the window size as 6000 based on sequence numbers 0 to 5999 of the same measurement group. The CPU 31 stores the value of 5999 as the end sequence number in the analysis information table 354.

The CPU 31 stores the value of 6000 of the previous window size in the analysis information table 354. In a case where the window size is the greatest within the same connection ID, the CPU 31 stores this window size as the maximum window size in the analysis information table 354. The CPU 31 calculates the amount of increase by subtracting the previous window size from the current window size, and stores the resultant value as the amount of increase in the RAM 32. The CPU 31 detects the maximum amount of increase from among the amounts of increases stored in the RAM 32, and stores the detected value as the maximum amount of increase in the analysis information table 354. In the example illustrated in FIG. 10, 2500 is stored as the maximum amount of increase. Thereafter, the CPU 31 changes the measurement status to WAIT_ACK.

In a case where a packet loss has not yet occurred, the CPU 31 stores NO_LOSS as the loss status in the analysis information table 354. When a packet loss occurs, the CPU 31 stores RTT (RTTLoss) as of immediately before the occurrence of the loss in the RAM 32. Furthermore, the CPU 31 stores the window size (previous window size) as of immediately before the occurrence of the loss in the RAM 32. The CPU 31 changes the loss status to NOW_LOSS. After the loss status changes to PRE_LOSS thereafter, the CPU 31 counts the number of occurrences of a packet loss as the second number of times, and stores the counted second number of times in the analysis information table 354.

After the loss status changes to PRE_LOSS, the CPU 31 calculates a second amount of reduction by subtracting the window size as of immediate after the occurrence of the loss from the window size as of immediately before the occurrence of the loss stored in the RAM 32. The CPU 31 stores the second amount of reduction in the RAM 32. Each time a packet loss occurs, the CPU 31 calculates the second amount of reduction. In a case where the CPU 31 receives FIN data transmitted when a connection via TCP is ended, the CPU 31 calculates the average second amount of reduction by dividing the sum of second amounts of reduction by the second number of times, and the CPU 31 stores the calculated average second amount of reduction in the RAM 32. In a case where a packet loss occurs, the CPU 31 stores, in the RAM 32, the sum of window sizes as of immediately before the occurrence of the packet loss (hereinafter, referred to as an immediately previous sum).

The CPU 31 determines whether congestion due to a delay is occurring. For example, when the maximum RU stored in the RAM 32 is greater than the RU as of immediately before the occurrence of the packet loss, the CPU 31 determines that congestion due to a delay is occurring. The CPU 31 stores, in the analysis information table 354, the first number of times indicating the number of times that it is determined that the maximum RU stored in the RAM 32 is greater than the RU as of immediately before the occurrence of the loss, that is, the number of occurrences of congestion. The CPU 31 then calculates the first amount of reduction by subtracting the window size as of immediately after the occurrence of the loss, from the window size as of immediate before the occurrence of the loss stored in the RAM 32. The CPU 31 stores the first amount of reduction in the RAM 32. Note that each time it is determined that congestion due to a delay occurs, the CPU 31 calculates the first amount of reduction. In a case where the CPU 31 receives FIN data transmitted when a connection via TCP is ended, the CPU 31 calculates the average first amount of reduction by dividing the sum of first amounts of reduction by the first number of times, and stores the result in the RAM 32.

In a case where a connection is ended and thus FIN is received, the CPU 31 determines a type of congestion control that may be performed by the computer 1. For example, there may be four candidates for a type of congestion control. A first candidate is a first type of congestion control that includes a slow loss-based control, such as Tahoe, or Renoin, in which a congestion state is detected from a packet loss, and a slow delay-based control, such as Vegas, in which a congestion state is detected from RTT. A second candidate is a second type of congestion control, such as Compand TCP (CTCP), or Westwood, based on a fast delay-based congestion control in which a congestion state is detected from RTT and the congestion control is performed such that a whole bandwidth is effectively used even in a wideband network.

A third candidate is a third type of congestion control, such as BIC, or CUBIC, based on a fast loss-based congestion control in which a congestion state is detected from a packet loss and the congestion control is performed such that a whole bandwidth is effectively used even in a wideband network. Hereinafter, other type of congestion control different from any of the first to third types of congestion control described above will be referred to as a fourth type of congestion control.

A procedure is described below as to a process of determining which one of the first to fourth types of congestion control is being performed by the computer 1. The CPU 31 reads out a threshold value from the storage unit 35. In the embodiment, a value that is equal to the MTU, stored in the storage unit 35, multiplied by a coefficient, is employed as the threshold value. The CPU 31 determines whether the maximum amount of increase stored in the analysis information table 354 is greater than the read threshold value. In a case where it is determined that the maximum amount of increase is not greater than the threshold value, the CPU 31 determines that the estimated window size is linearly increasing, and the first type of congestion control is employed by the computer 1.

In a case where it is determined that the maximum amount of increase is greater than the threshold value, the CPU 31 determines that the estimated window size is nonlinearly increasing, and a fast congestion control, that is, one of the second type of congestion control, the third type of congestion control, and the fourth type of congestion control, is employed by the computer 1. The CPU 31 reads out the average first amount of reduction stored in the RAM 32. The CPU 31 determines whether the read average first amount of reduction is greater than the threshold value. In a case where the CPU 31 determines that the average first amount of reduction is not greater than the threshold value, the CPU 31 determines that the second type of congestion control is being used by the computer 1.

In a case where the CPU 31 determines that the average first amount of reduction is not greater than the threshold value, the CPU 31 estimates that a large increase in window size occurs even when a large delay occurs, and thus an influence of a delay is smal. Thus the CPU 31 determines that the third type of congestion control or the fourth type of congestion control is being used by the computer 1. The CPU 31 determines whether the average second amount of reduction is greater than a second threshold value. Note that the second threshold value may be a greater one of following two values: a value (threshold value) equal to MTU multiplied by a first coefficient; and a value equal to the immediately previous sum divided by a second coefficient and the second number of times. The CPU 31 stores the second threshold value in the RAM 32.

In a case where the CPU 31 determines that the average second amount of reduction is greater than the second threshold value, the CPU 31 determines, from the fact that a large reduction in the window size occurs when a packet loss occurs, that the packet loss has a large influence, and thus the CPU 31 determines that the third congestion control is being used by the computer 1. In a case where the CPU 31 determines that the average second amount of reduction is not greater than the second threshold value, the CPU 31 determines that the fourth type of congestion control is being used by the computer 1.

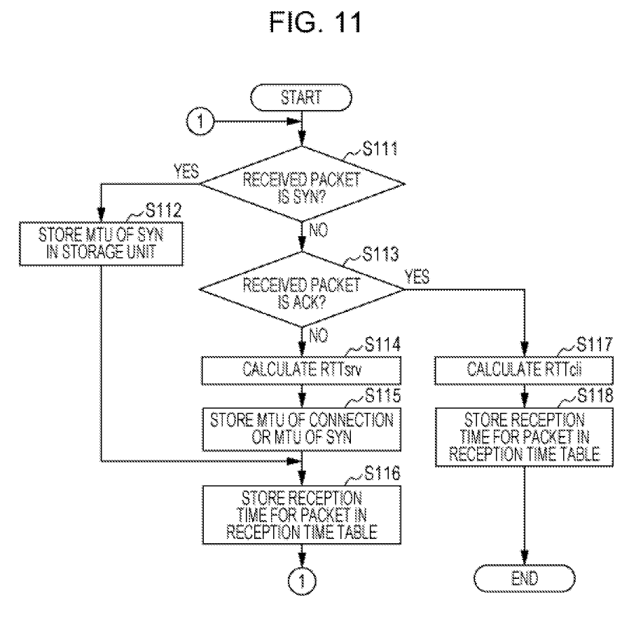

With the set of hardware described above, various software processes are performed as described below referring to flow charts. FIG. 11 is an operational flowchart illustrating a procedure of a three-way handshaking process. The CPU 31 determines whether a received packet is SYN (step S111). In a case where the CPU 31 determines that the received packet is SYN (YES in step S111), the CPU 31 advances the processing flow to step S112. The CPU 31 stores MTU of SYN in the storage unit 35 (step S112). The CPU 31 stores a reception time of a packet and SYN in the reception time table 351 (step S116).

In a case where the CPU 31 determines that the received packet is not SYN (NO in step S111), the CPU 31 advances the processing flow to step S113. The CPU 31 determines whether the received packet is ACK (step S113). In a case where the CPU 31 determines that the received packet is not ACK (NO in step S113), the CPU 31 advances the processing flow to step S114. The CPU 31 subtracts the reception time of SYN from the present time thereby determining RTTsrv (step S114). The CPU 31 stores the calculated RTTsrv in the storage unit 35. The CPU 31 detects a smaller one of a MTU of a connection and a MTU of SYN, and stores the detected MTU in the analysis information table 354 (step S115).

The CPU 31 stores the packet reception time and SYN/ACK in the reception time table 351 (step S116). The CPU 31 then returns the processing flow to step S111. In a case where CPU 31 determines that the received packet is ACK (YES in step S113), the CPU 31 advances the processing flow to step S117. The CPU 31 subtracts the previous packet reception time from the present time, thereby determining RTTcli (step S117). The CPU 31 stores the calculated RTTcli in the storage unit 35. The CPU 31 stores the reception time of the packet and ACK in the reception time table 351 (step S118).

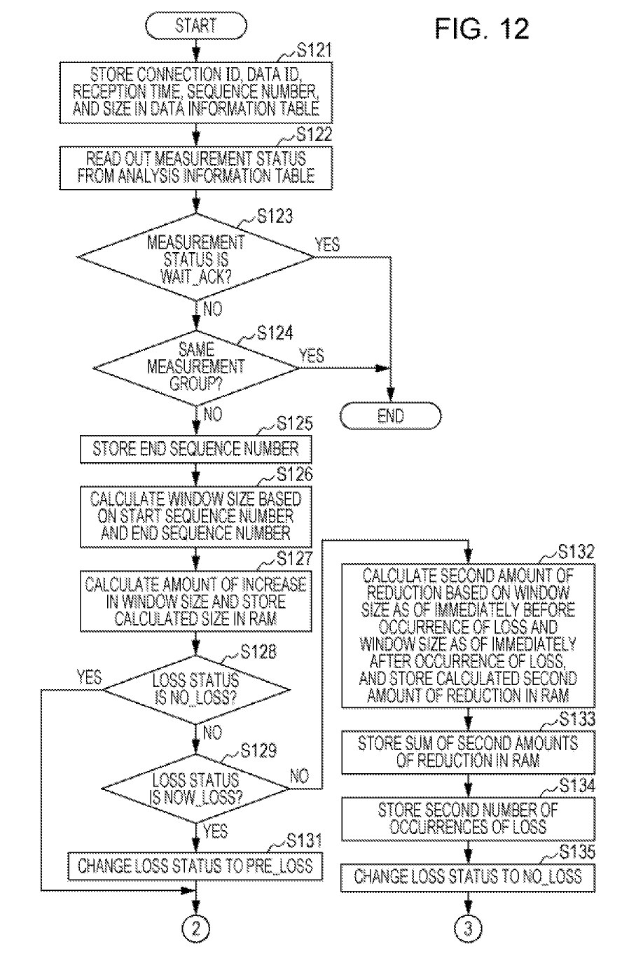

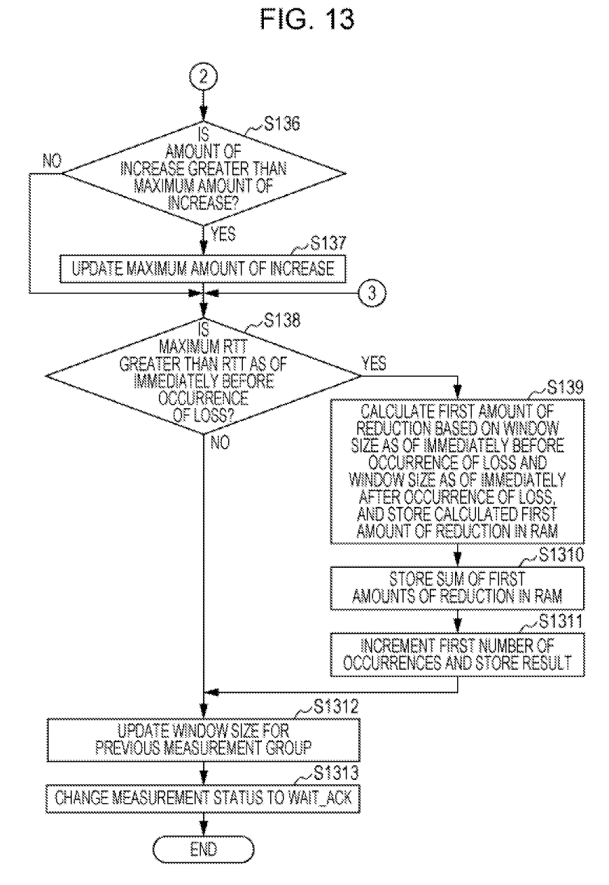

FIG. 12 and FIG. 13 are operational flowcharts illustrating a procedure of a measurement process. In a case where data is received, the CPU 31 stores a connection ID, a data ID, a reception time, a sequence number, and a size in the data information table 352 (step S121). The CPU 31 reads out a measurement status from the analysis information table 354 (step S122). Note that the initial value of the measurement status is WAIT_ACK. The CPU 31 determines whether the measurement status is WAIT_ACK (step S123). In a case where the CPU 31 determines that the measurement status is WAIT_ACK (YES in step S123), the CPU 31 ends the process.

In a case where the CPU 31 determines that the measurement status is not WAIT_ACK (NO in step S123), that is, the measurement status is WAIT_DATA, the CPU 31 advances the processing flow to step S124. In a case where ACK is received, the CPU 31 jumps to a subroutine described below.

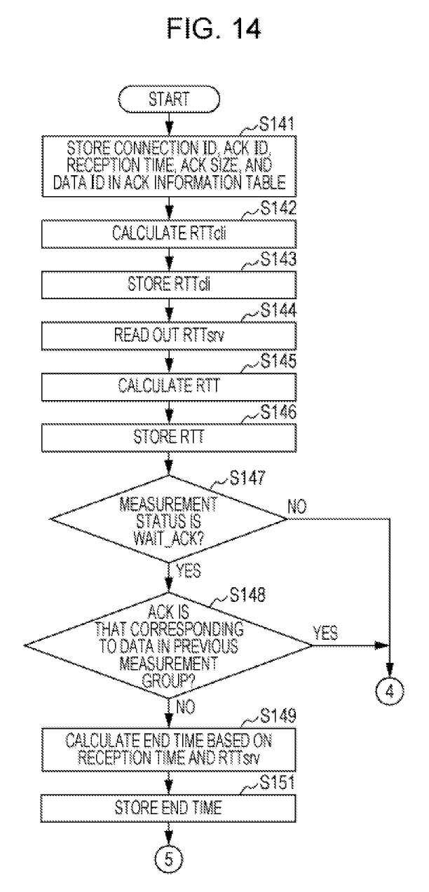

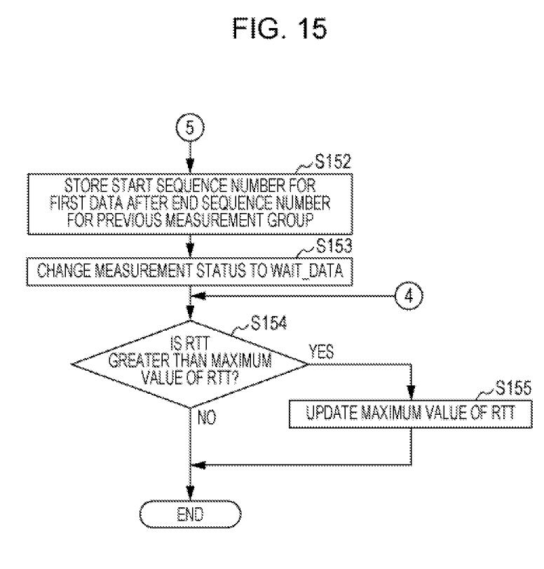

FIG. 14 and FIG. 15 are operational flowcharts illustrating a procedure of a process performed when ACK is received. When ACK is received, the CPU 31 stores a connection ID, an ACK ID, a reception time, an ACK size, and a data ID in the ACK information table 353 (step S141). More specifically, the CPU 31 adds a data size stored in the data information table 352 to a sequence number, thereby determining the ACK size. Furthermore, the CPU 31 extracts, from the data information table 352, a data ID with a sequence number immediately smaller than the ACK size. The CPU 31 subtracts a reception time corresponding to the extracted data ID from the reception time of ACK, thereby determining RTTcli (second round trip time) (step S142).

The CPU 31 stores calculated RTTcli in the analysis information table 354 (step S143). The CPU 31 reads out RTTsrv (first round trip time) calculated in step S114 from the analysis information table 354 (step S144). The CPU 31 adds RTTsrv to RTTcli, thereby determining estimated RTT (step S145). The CPU 31 stores calculated RTT as previous RTT in the analysis information table 354 (step S146).

The CPU 31 checks the analysis information table 354 to determine whether the measurement status is WAIT_ACK (step S147). In a case where the CPU 31 determines that the measurement status is not WAIT_ACK (NO in step S147), the CPU 31 advances the processing flow to step S154. When the CPU 31 determines that the measurement status is WAIT_ACK (YES in step S147), the CPU 31 advances the processing flow to step S148. The CPU 31 determines whether the received ACK is ACK corresponding to data of the previous measurement group (step S148).

In a case where the CPU 31 determines that the received ACK is ACK corresponding to data of the previous measurement group (YES in step S148), the CPU 31 advances the processing flow to step S154. In a case where the CPU 31 determines that the received ACK is not one corresponding to data of the previous measurement group (NO in step S148), the CPU 31 advances the processing flow to step S149. The CPU 31 calculates the end time, based on the ACK reception time and RTTsrv read out in step S144 (step S149). More specifically, the CPU 31 adds RTTsrv to the ACK reception time, thereby determining an end time. The CPU 31 stores the calculated end time in the analysis information table 354 (step S151).

The CPU 31 stores, in the analysis information table 354, a start sequence number of first data that appears following the data corresponding to the sequence number of the previously measured group (step S152). The CPU 31 changes the measurement status to WAIT_DATA (step S153). The CPU 31 determines whether the RTT calculated in step S145 is greater than the maximum RTT stored in the RAM 32 (step S154). In a case where the CPU 31 determines that the RTT is greater than the maximum RTT (YES in step S154), the CPU 31 updates the maximum RTT for the current measurement group (step S155). In a case where the CPU 31 determines that the RTT is not greater than the maximum RTT (NO in step S154), the CPU 31 skips a process in step S155.

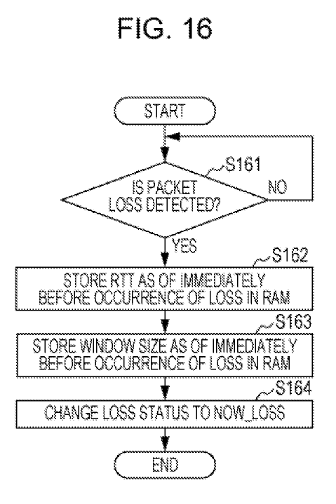

FIG. 16 is an operational flowchart illustrating a procedure of a process performed when a packet loss occurs. The CPU 31 determines whether a packet loss has occurred (step S161). More specifically, in a case where no packet has been received over a continuous period with a predetermined length or in a case where identical packets have been received, the CPU 31 determines that a packet loss has occurred. In a case where the CPU 31 determines that no packet loss has occurred (NO in step S161), the CPU 31 waits until a packet loss occurs. In a case where the CPU 31 determines that a packet loss has occurred (YES in step S161), the CPU 31 advances the processing flow to step S162.

The CPU 31 stores RTT as of immediately before the occurrence of the packet loss in the RAM 32 (step S162). The CPU 31 stores the window size as of immediately before the occurrence of the packet loss in the RAM 32 (step S163). The CPU 31 changes the loss status to NOW_LOSS (step S164).

Referring again to FIG. 12, the process in step S124 and following steps will be described. The CPU 31 determines whether the received packet is one belonging to the same measurement group (step S124). More specifically, the CPU 31 makes this determination based on whether the reception time is earlier than the end time calculated in step S149. In a case where the CPU 31 determines that the received packet is one belonging to the same measurement group (YES in step S124), the CPU 31 end the process. On the other hand, in a case where the CPU 31 determines that the received packet is not one belonging to the same measurement group (NO in step S124), the CPU 31 advances the processing flow to step S125.

The CPU 31 stores an end sequence number in the analysis information table 354 (step S125). The CPU 31 calculates the window size based on the start sequence number and the end sequence number stored in the analysis information table 354 (step S126). More specifically, the CPU 31 subtracts the start sequence number from the end sequence number and adds 1 to the result, thereby determining the estimated window size. The CPU 31 stores the calculated window size in the analysis information table 354. The CPU 31 calculates the amount of increase in the window size from the window size for the previous measurement group, and stores the calculated amount of increase in the RAM 32 (step S127).

The CPU 31 checks the analysis information table 354 to determine whether the loss status is NO_LOSS (step S128). In a case where the CPU 31 determines that the loss status is NO_LOSS (YES in step S128), the CPU 31 advances the processing flow to step S136. In a case where it is determined that the loss status is not NO_LOSS (NO in step S128), the CPU 31 advances the processing flow to step S129. The CPU 31 determines whether the loss status is NOW_LOSS (step S129). In a case where the CPU 31 determines that the loss status is NOW_LOSS (YES in step S129), the CPU 31 advances the processing flow to step S131. The CPU 31 changes the loss status to PRE_LOSS (step S131). Thereafter, the CPU 31 advances the processing flow to step S136.

In a case where the CPU 31 determines that the loss status is not NOW_LOSS (NO in step S129), the CPU 31 determines that the loss status is PRE_LOSSm, and the CPU 31 advances the processing flow to step S132. The CPU 31 calculates a second amount of reduction, based on the window size as of immediately before the occurrence of the loss and the window size as of immediately after the occurrence of the loss, and the CPU 31 stores the calculation result in the RAM 32 (step S132). For example, the CPU 31 calculates the difference between the window size as of immediately before the occurrence of the loss and the window size as of immediately after the occurrence of the loss, thereby determining the second amount of reduction.

The CPU 31 calculates the sum of second amounts of reduction stored in the RAM 32 and stores the calculated sum in RAM 32 (step S133). The CPU 31 stores a second number of occurrences of packet loss in the analysis information table 354 (step S134). The CPU 31 changes the loss status to NO_LOSS (step S135). Thereafter, the CPU 31 advances the processing flow to step S138.

The CPU 31 determines whether the amount of increase calculated in step S127 is greater than the maximum amount of increase (step S136). In a case where the CPU 31 determines that the amount of increase calculated in step S127 is greater than the maximum amount of increase (YES in step S136), the CPU 31 advances the processing flow to step S137. The CPU 31 updates the maximum amount of increase with the amount of increase calculated in step S127 (step S137). In a case where the CPU 31 determines that the amount of increase calculated in step S127 is not greater than the maximum amount of increase (NO in step S136), the CPU 31 skips the process in step S137, and the CPU 31 advances the processing flow to step S138.

The CPU 31 determines whether there is congestion due to a delay. For example, the CPU 31 determines whether the maximum RTT is greater than the RTT as of immediately before the occurrence of the loss (step S138). In a case where the CPU 31 determines that the maximum RTT is greater than the RTT as of immediately before the occurrence of the loss (YES in step S138), the CPU 31 advances the processing flow to step S139. The CPU 31 calculates a first amount of reduction, based on the window size as of immediately before the occurrence of the loss and the window size as of immediately after the occurrence of the loss, and the CPU 31 stores the calculated first amount of reduction in the RAM 32 (step S139). For example, the CPU 31 calculates the difference between the window size as of immediately before the occurrence of the loss and the window size as of immediately after the occurrence of the loss, thereby determining the first amount of reduction.

The CPU 31 calculates the sum of first amounts of reduction and stores it in the RAM 32 (step S1310). The CPU 31 increments the first number of times that the determination in step S138 is YES, and stores the incremented value in the analysis information table 354 (step S1311). Thereafter, the CPU 31 advances the processing flow to step S1312. In a case where the CPU 31 determines that the maximum RTT is not greater than the RTT as of immediately before the occurrence of the loss (NO in step S138), the CPU 31 advances the processing flow to step S1312.

The CPU 31 reads the window size calculated in step S126, and updates the window size for the previous measurement group (step S1312). The CPU 31 changes the measurement status in the analysis information table 354 to WAIT_ACK (step S1313).

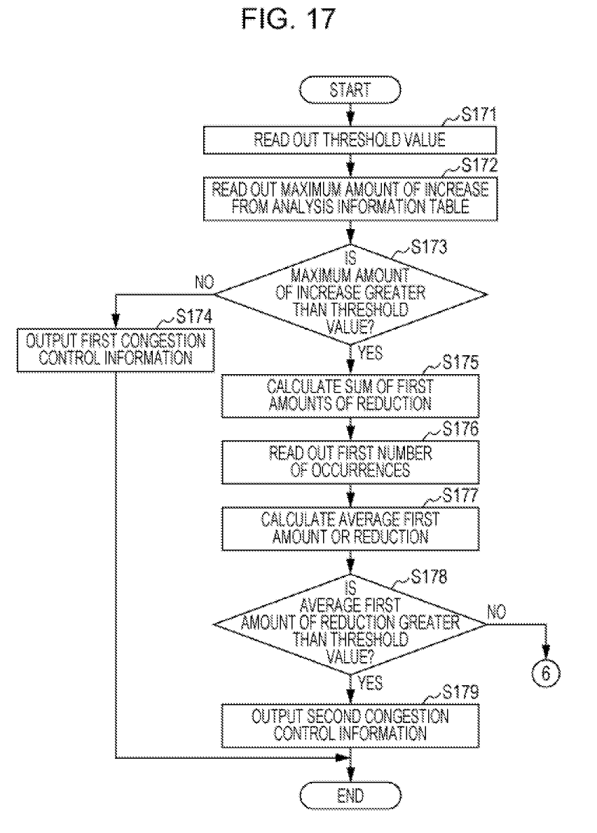

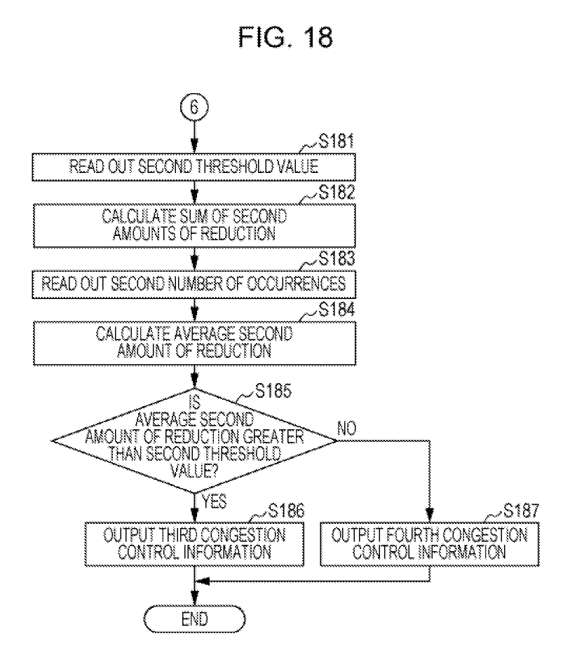

FIG. 17 and FIG. 18 are operational flowcharts illustrating a procedure of determining a type of congestion control. The CPU 31 reads out a threshold value stored in the RAM 32 (step S171). The CPU 31 reads out the maximum amount of increase from the analysis information table 354 (step S172). The CPU 31 determines whether the maximum amount of increase is greater than the threshold value (step S173). In a case where the CPU 31 determines that the maximum amount of increase is not greater than the threshold value (NO in step S173), the CPU 31 advances the processing flow to step S174. The CPU 31 outputs, to the display unit 34, information (congestion control information) indicating that the congestion control being performed by the computer 1 is the first type of congestion control among a plurality of candidates for congestion control (step S174). Note that although it is assumed in the embodiment by way of example that the congestion control information is output to the display unit 34, the device to which the congestion control information is output is not limited to the display unit 34.

For example, the congestion control information may be transmitted to another not-illustrated computer. In a case where the CPU 31 determines that the maximum amount of increase is greater than the threshold value (YES in step S173), the CPU 31 advances the processing flow to step S175. The CPU 31 calculates the sum of the first amounts of reduction stored in the RAM 32 (step S175). The CPU 31 reads out the first number of times stored in the analysis information table 354 (step S176). The CPU 31 divides the sum of the first amounts of reduction by the first number of times, thereby determining the average first amount of reduction (step S177).

The CPU 31 determines whether the average first amount of reduction is greater than the threshold value (step S178). In a case where the CPU 31 determines that the average first amount of reduction is greater than the threshold value (YES in step S178), the CPU 31 advances the processing flow to step S179. The CPU 31 outputs, to the display unit 34, second congestion control information indicating the second type of congestion control (step S179). In a case where the CPU 31 determines that the average first amount of reduction is not greater than the threshold value (NO in step S178), the CPU 31 advances the processing flow to step S181.

The CPU 31 reads out a second threshold value from the RAM 32 (step S181). The CPU 31 calculates the sum of the second amounts of reduction (step S182). The CPU 31 reads out the second number of times from the analysis information table 354 (step S183). The CPU 31 divides the sum of the second amounts of reduction by the second number of times, thereby determining the average second amount of reduction (step S184). The CPU 31 determines whether the average second amount of reduction is greater than the second threshold value (step S185).

In a case where the CPU 31 determines that the average second amount of reduction is greater than the second threshold value (YES in step S185), the CPU 31 advances the processing flow to step S186. The CPU 31 outputs, to the display unit 34, third congestion control information indicating that the congestion control being performed by the computer 1 is the third type of congestion control (step S186). In a case where the CPU 31 determines that the average second amount of reduction is not greater than the second threshold value (NO in step S185), the CPU 31 advances the processing flow to step S187. The CPU 31 outputs, to the display unit 34, fourth congestion control information indicating that the congestion control being performed by the computer 1 is the fourth type of congestion control (step S187). This makes it possible to determine the type of the congestion control performed by the computer 1. It also becomes possible to accurately determine, from many congestion control candidates, the congestion control most likely to be being performed by computer 1 by estimating the window size.

### Second Embodiment

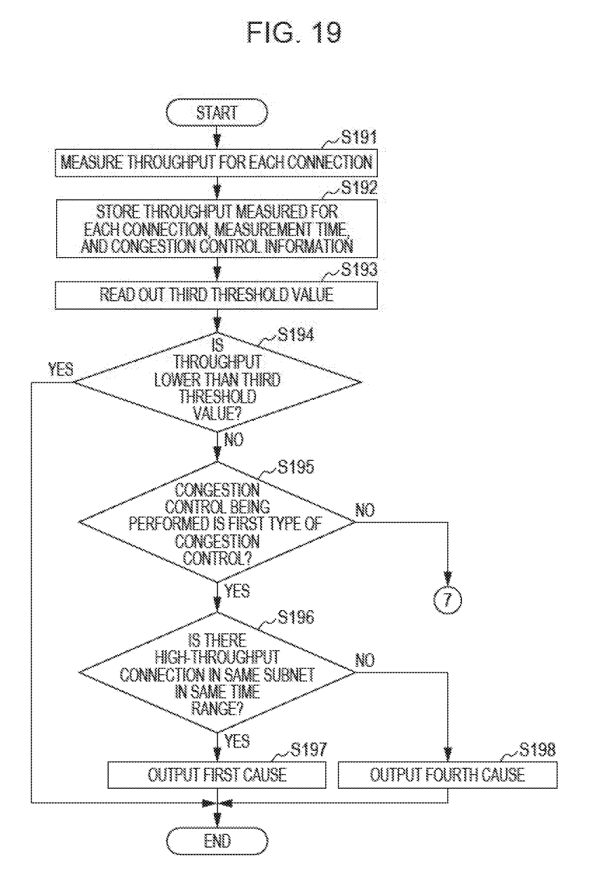

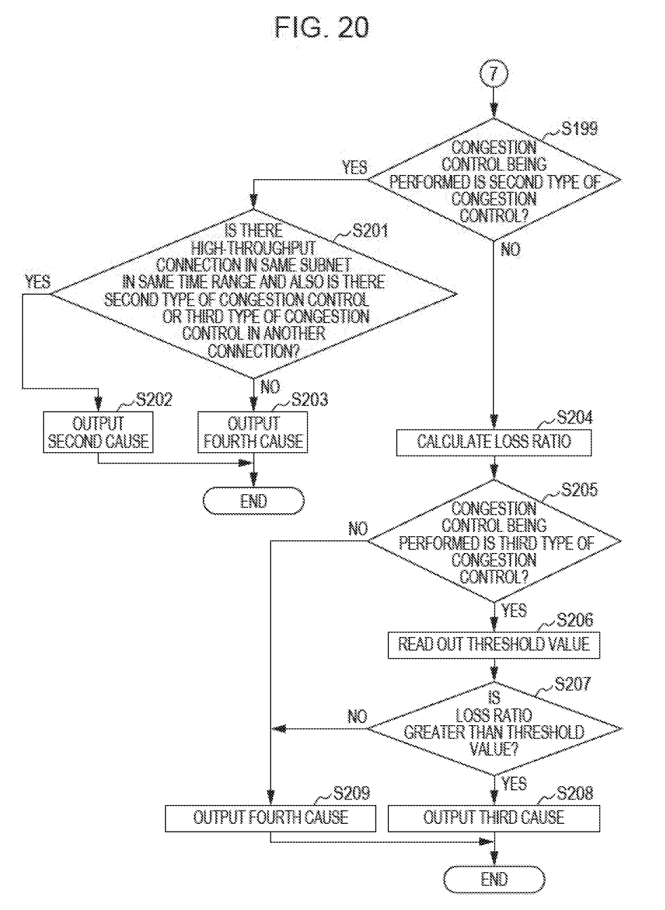

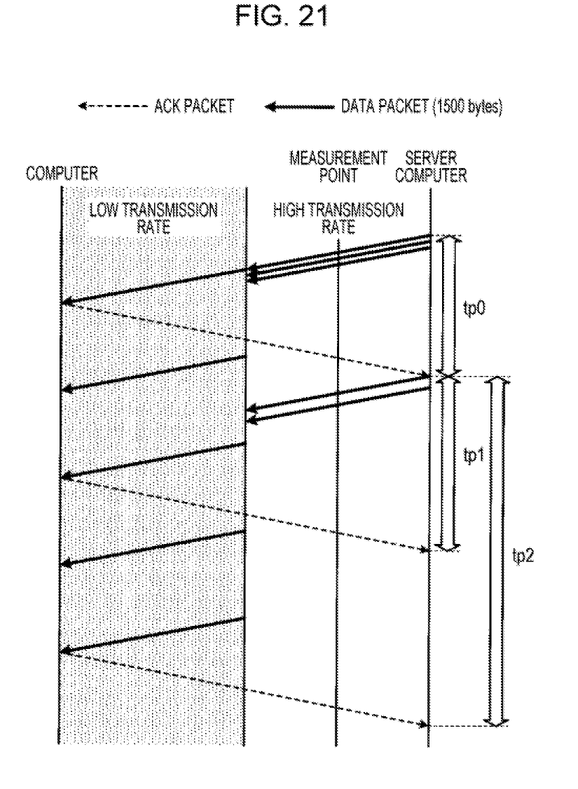

A second embodiment described below relates to a technique of outputting information on a cause of a delay in the first to fourth congestion controls. FIG. 19 and FIG. 20 are operational flowcharts illustrating a procedure of outputting information on a cause. The CPU 31 measures a throughput for each connection (step S191). Details of the throughput measurement process will be described later. The CPU 31 stores, in the storage unit 35, the throughput measured for each connection, a measurement time (a measurement start time and a measurement end time) of the throughput, and information on the congestion control performed by the computer 1 described above in the first embodiment (step S192).

The CPU 31 reads out a third threshold value stored in advance in the storage unit 35 (step S193). The CPU 31 determines whether the throughput of the computer 1 of interest is equal to or lower than the third threshold value (step S194). In a case where the throughput is equal to or lower than the third threshold value (YES in step S194), the CPU 31 ends the process. In a case where the CPU 31 determines that the throughput is higher than the third threshold value (NO in step S194), the CPU 31 advances the processing flow to step S195. The CPU 31 determines, by performing the process described in the first embodiment, whether the congestion control by the computer 1 is the first congestion control (step S195).

In a case where the CPU 31 determines that the congestion control is the first type of congestion control (YES in step S195), the CPU 31 advances the processing flow to step S196. The CPU 31 checks the storage unit 35 to determine whether there is a connection having a high throughput in the same time period in the same subnet (step S196). More specifically, the CPU 31 reads out a measure time period (a start time and an end time) for a connection determined to be subjected to first congestion control. The CPU 31 determines whether there is, in the throughputs of the respective connections stored in step S192, a throughput higher than a predetermined threshold value in the read time period.

In a case where the CPU 31 determines that there is a connection having a high throughput in the time period (YES in step S196), the CPU 31 advances the processing flow to step S197. The CPU 31 reads out first cause information from the storage unit 35. More specifically, the CPU 31 reads out, from the storage unit 35, information (the first cause information) indicating that the congestion control performed by the computer 1 is highly likely to be a cause of delay. The CPU 31 outputs the read first cause to the display unit 34 (step S197). Although in the embodiment it is assumed by way of example that the cause is output to the display unit 34, the device to which the cause is output is not limited to the display unit 34. For example, the first cause may be transmitted to another not-illustrated computer.

In a case where the CPU 31 determines that there is no connection having a high throughput in the same time period (NO in step S196), the CPU 31 reads out, from the storage unit 35, information (fourth cause information) indicating that the network bandwidth is highly likely to be a cause. The CPU 31 outputs the read fourth cause information to the display unit 34 (step S198). After step S197 and step S198 are completed, the CPU 31 ends the process.

In a case where the CPU 31 determines that the congestion control is not the first type of congestion control (NO in step S195), the CPU 31 advances the processing flow to step S199. The CPU 31 determines whether the congestion control is the second type of congestion control (step S199). In a case where the CPU 31 determines that the congestion control is the second type of congestion control (YES in step S199), the CPU 31 advances the processing flow to step S201. The CPU 31 determines whether there is a connection having a high throughput in the same time period in the same subnet and there is another connection subjected to the second type of congestion control or the third type of congestion control (step S201).

More specifically, the CPU 31 reads out a measure time period (a start time and an end time) for a connection determined to be subjected to the second type of congestion control. The CPU 31 checks the throughputs of respective connections stored in step S192 to determine whether there is a throughput higher than a predetermined threshold value in the read time period. Furthermore, the CPU 31 checks congestion control information associated with other connection stored in step S192 to determine whether the congestion control described in the first embodiment is the second type of congestion control or the third type of congestion control.

In a case where the CPU 31 determines that there is a connection having a high throughput and there is another connection subjected to the second type of congestion control or the third type of congestion control (YES in step S201), the CPU 31 advances the processing flow to step S202. The CPU 31 reads out, from the storage unit 35, information (second cause information) indicating that the cause is that the congestion is a mixture of the second type of congestion control and the third type of congestion control and this results in congestion in the network bandwidth. The CPU 31 outputs the second cause information to the display unit 34 (step S202). In a case where the CPU 31 does not determine that there is a connection having a high throughput and there is another connection subjected to the second type of congestion control or the third type of congestion control (NO in step S201), the CPU 31 advances the processing flow to step S203.

The CPU 31 reads out, from the storage unit 35, information (fourth cause information) indicating that the network bandwidth is highly likely to be a cause. The CPU 31 outputs the read the fourth cause information to the display unit 34 (step S203). After step S202 and step S203 are completed, the CPU 31 ends the process.

In a case where it is determined that the congestion control is not the second type of congestion control (NO in step S199), the CPU 31 advances the processing flow to step S204. The CPU 31 calculates a loss rate (step S204). More specifically, the CPU 31 divides the number of occurrences of packet loss for each connection by the total number of pieces of data, thereby determining the loss rate. The CPU 31 determines whether the congestion control performed by the computer 1 is the third type of congestion control (step S205). In a case where the CPU 31 determines that the congestion control is the third type of congestion control (YES in step S205), the CPU 31 advances the processing flow to step S206. The CPU 31 reads out a threshold value from the storage unit 35 (step S206).

The CPU 31 determines whether the loss rate is equal to or greater than the threshold value read from the storage unit 35 (step S207). In a case where the CPU 31 determines that the loss rate is equal to or greater than the threshold value (YES in step S207), the CPU 31 advances the processing flow to step S208. The CPU 31 reads out, from the storage unit 35, information (third cause information) indicating that the delay is caused by the congestion control and the loss rate. The CPU 31 outputs the read third cause information to the display unit 34 (step S208).

In a case where it is determined that the congestion control is not the third type of congestion control (NO in step S205), or in a case where it is determined that the loss rate is lower than the threshold value (NO in step S207), the CPU 31 advances the processing flow to step S209. The CPU 31 reads out, from the storage unit 35, information (fourth cause information) indicating that the network bandwidth is highly likely to be a cause. The CPU 31 outputs the read fourth cause information to the display unit 34 (step S209). After steps S208 and S209 are completed, the CPU 31 ends the process. This makes it possible to determine the cause of the delay as well as the type of the congestion control being performed by the computer 1. Furthermore, it becomes possible to more accurately identify the cause of the delay depending on the congestion controls employed in other connections, the loss rate, and/or the like.

The second embodiment has been described above. Other processes, elements, and the like similar to those in the first embodiment are denoted by similar reference numerals or symbols, and a further description thereof is omitted.

### Third Embodiment

A third embodiment described below relates to a technique of measuring a throughput. In the throughput measurement described above, the CPU 31 divides the congestion window (cwnd) by RTT according to equation (1), thereby estimating the throughput. RTT refers to a time from transmission of a data packet to reception of an ACK packet, that is, RTT is a round trip delay time. The congestion window refers to an amount of data of data packets flowing in the RTT.

Throughput [bps]=cwnd [bits]/RTT [sec] (1)

In a case where there is a low speed interval on the receiving side, in a case where RTT is short, or in a case where cwnd is large, the throughput may be estimated as follows. FIG. 21 is a diagram illustrating a status in terms of transmission and reception of data. As illustrated in FIG. 21, at a measurement point, the CPU 31 transmits a measurement group (hereinafter referred to simply as a group) which is a set of one or more pieces of data (DATA) from the sever computer 2 serving as a transmission terminal to the computer 1 serving as a reception terminal. The CPU 31 measures an estimated value of a TCP throughput, based on RTT for first DATA in the group and the amount of data of DATA in the group. In the present example, RTT is tp0, and the amount of data of DATA in the group is cwind, which is 1500×3 [bytes] in this case.

The CPU 31 calculates an approximated value of a network bandwidth from a time from acquisition of a first ACK to acquisition of a last ACK in the measurement group, and the amount of data DATA excluding the first DATA in the group. In the present example, the time from the acquisition of the first ACK to the acquisition of the last ACK, that is, the ACK interval, is tp1.

The CPU 31 compares the estimated value of the TCP throughput with the approximated value of the network bandwidth to determine whether it is reasonable to regard the estimated value of the TCP throughput as an effective throughput. That is, the CPU 31 determines the validity of the estimated value of the TCP throughput, based on the throughput determined from the ACK interval in the group. When the estimated value of the TCP throughput is not greater than the approximated value of the network bandwidth, the CPU 31 determines that the estimated value of the TCP throughput is reasonable, and the CPU 31 employs the estimated value of the TCP throughput as the effective throughput.

When the estimated value of the TCP throughput is greater than the approximated value of the network bandwidth, the CPU 31 determines that the employment of the estimated value of the TCP throughput is not reasonable, and the CPU 31 determines whether it is reasonable to employ the approximated value of the network bandwidth as the effective throughput. For example, the CPU 31 estimates the value of the throughput measured from a second ACK interval including ACK in a next measurement group following the measurement group and the amount of data thereof. In the present example, the second ACK interval is tp2. The CPU 31 compares this estimated value with the estimated value of the TCP throughput and determines the validity of the approximated value of the network bandwidth.

When the estimated value of the TCP throughput is greater than the value of the throughput measured from the second ACK interval, the CPU 31 determines that the approximated value of the network bandwidth is reasonable, and the CPU 31 determines the approximated value of the network bandwidth as the effective throughput. When the estimated value of the TCP throughput is not greater than the value of the throughput measured from the second ACK interval, the CPU 31 determines that the approximated value of the network bandwidth is not reasonable, and the CPU 31 employs the estimated value of the TCP throughput as the effective throughput.

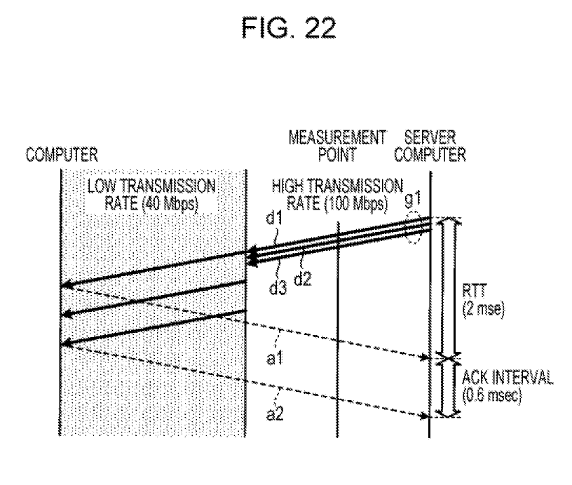

FIG. 22 to FIG. 25 are diagrams each illustrating a status in terms of transmission and reception of data. As illustrated in FIG. 22, it is assumed in the following discussion by way of example that a group g1, which is a set of DATA, includes three pieces of DATA, and the amount of data of each piece of DATA is 1500 bytes. Furthermore, it is assumed that RTT is 2 msec, and the ACK interval is 0.6 msec.

The CPU 31 substitutes RTT and cwind into formula (1), thereby calculating the estimated value TP_{tcp} of the TCP throughput. In the present example, cwind is the amount of data for DATA d1 to d3, and is 8× (3×1500 [bytes]) bits. RTT is 2 msec. Thus, the estimated value TP_{tcp} of the TCP throughput is determined as follows.

TP_{tcp}=8×(3×1500[bytes])/2[msec]=18[Mbps] (2)

The CPU 31 calculates the approximated value TP_{rcv1} of the network bandwidth from the ACK interval and the amount of data of DATA excluding the first DATA in the group. Note that the ACK interval is a time period from the acquisition of a first ACK a1 to the acquisition of a last ACK a2 in the group. The amount of data of DATA is given by the amount of data (second amount of packets) of DATA d2 and d3 excluding the first DATA d1 in the group g1, and thus given as 8×(2×1500 [bytes]) bits. The ACK interval is 0.6 msec. The approximated value TP_{rcv1} of the network bandwidth is calculated as follows.

TP=8×(2×1500[bytes])/0.6[msec]=40[Mbps] (3)

The CPU 31 determines the validity of the estimated value of the TCP throughput by comparing the estimated value TP_{tcp} of the TCP throughput with the approximated value TP_{rcv1} of the network bandwidth. In this case, estimated value TP_{tcp} of the TCP throughput is not greater than the approximated value TP_{rcv1} of the network bandwidth, and thus the CPU 31 employs the estimated value TP_{tcp} of the TCP throughput as the effective throughput. That is, in this case, the employment of the estimated value TP_{tcp} of the TCP throughput is reasonable.

In this situation, the estimated value TP_{tcp} of the TCP throughput is employed as the effective throughput for the following reasons. That is, when there is a low speed section of 40 Mbps on a receiving end, the actual transfer time to transfer DATA d1 to d3 is calculated as follows.

$$Actual transfer time = 8 \times ( 3 \times 1500 [ bytes ] ) \text{/} 40 [ Mbps ] = 0.9 [ msec ] \qquad ( 4 )$$

This calculation result indicates that the actual transfer time (0.9 msec) is shorter than RTT (2 msec), which means that there is an ineffective time in the network. Therefore, the estimated value TP_{tcp} of the TCP throughput is regarded as the effective throughput.

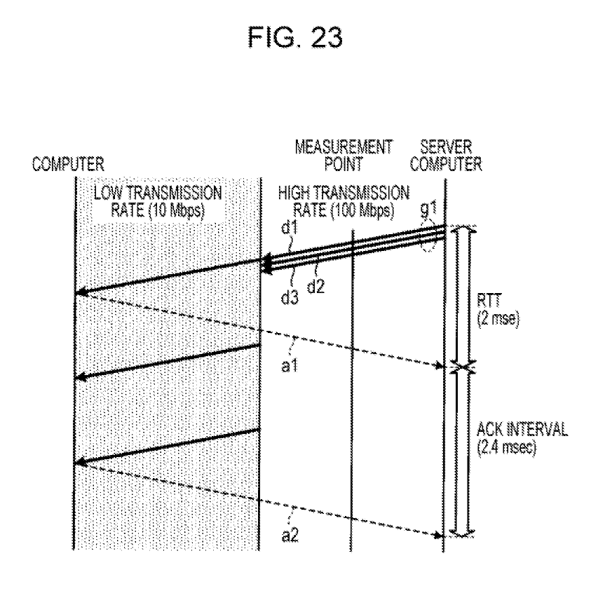

In FIG. 23, the number of pieces of DATA of a group g1 of DATA, the amount of data of each piece of DATA, and RTT are similar to those illustrated in FIG. 22. However, FIG. 23 is different from FIG. 22 in that the ACK interval is changed from 0.6 msec to 2.4 msec.

The CPU 31 substitutes RTT and cwind into formula (1), thereby calculating the estimated value TP_{tcp} of the TCP throughput. In this example, the estimated value TP_{tcp} of the TCP throughput is 18 [Mbps].

The CPU 31 calculates the approximated value TP of the network bandwidth from the ACK interval and the amount of data (second amount of packets) of DATA excluding the first DATA in the group g1. In this case, the ACK interval is 2.4 msec. The approximated value TP_{rcv1} of the network bandwidth is calculated as follows.

TP_{rcv1}=8×(2×1500[bytes])/2.4[msec]=10[Mbps] (5)

The CPU 31 determines the validity of the estimated value of the TCP throughput by comparing the estimated value TP_{tcp} of the TCP throughput with the approximated value TP_{rcv1} of the network bandwidth. In this case, the estimated value TP_{tcp} of the TCP is greater than the approximated throughput value TP_{rcv1} of the network bandwidth, and thus the CPU 31 determines that the employment of the estimated value TP_{tcp} of the TCP throughput is not reasonable, and thus CPU 31 determines the validity of the approximated value TP_{rcv1} of the network bandwidth.

In this situation, the estimated value TP_{tcp} of the TCP throughput is not employed as the effective throughput for the following reasons. That is, when there is a low speed section of 10 Mbps on a receiving end, the actual transfer time to transfer DATA d1 to d3 is calculated as follows.

$$Actual transfer time = 8 \times ( 3 \times 1500 [ bytes ] ) \text{/} 10 [ Mbps ] = 3.6 [ msec ] \qquad ( 6 )$$

This calculation result indicates that the actual transfer time (3.6 msec) is longer than RTT (2 msec), which means that there is no ineffective time in the network. Therefore, the estimated value TP_{tcp} of the TCP throughput is not regarded as the effective throughput. Therefore, next, the CPU 31 determines the validity of the approximated value TP_{rcv1} of the network bandwidth.

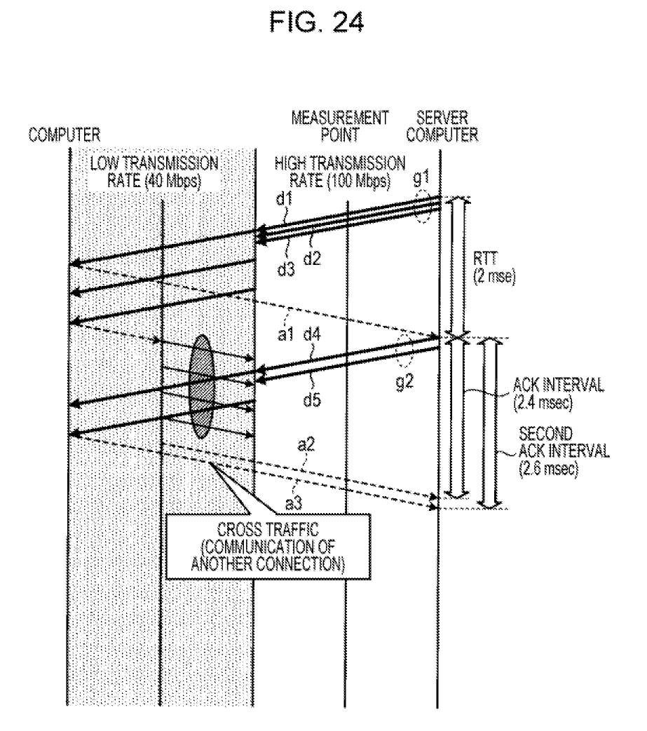

In FIG. 24, the number of pieces of DATA of a group g1 of DATA, the amount of data of each piece of DATA, RTT, and the ACK interval are similar to those illustrated in FIG. 23. However, FIG. 24 is different from FIG. 23 in that a next group g2 includes two pieces of DATA, and the second ACK interval is 2.6 msec.

The CPU 31 substitutes RTT and cwind into formula (1), thereby calculating the estimated value TP_{tcp} of the TCP throughput. In this example, the estimated value TP_{tcp} of the TCP throughput is 18 [Mbps].

The CPU 31 calculates the approximated value TP_{rcv1} of the network bandwidth from the ACK interval and the amount of data of DATA excluding the first DATA in the group. In the example, the approximated value TP_{rcv1} of the network bandwidth is 10 [Mbps] as with the case illustrated in FIG. 23.

In this case, estimated value TP_{tcp} of the TCP throughput is greater than the approximated value TP_{rcv1} of the network bandwidth, and thus the CPU 31 determines that the employment of the estimated value TP_{tcp} of the TCP throughput is not reasonable, and thus CPU 31 determines the validity of the approximated value TP_{rcv1} of the network bandwidth as follows. The CPU 31 calculates the throughput value TP_{rcv2} measured from the second ACK interval, the second amount of packets, and the amount of data of DATA d4 and d5 in the next group g2. In this case, the second ACK interval is 2.6 msec, the second amount of packets is 8×(2×1500 [bytes]) bits, and the amount of data of DATA d4 and d5 of the next group g2 is also 8×(2×1500 [bytes]) bits. Thus the throughput value TP_{rcv2} is calculated as follows.

TP_{rcv2}=8×(4×1500[bytes])/2.6[msec]=19.2[Mbps] (7)

In this case, the estimated value TP_{tcp} of the TCP throughput is not greater than the throughput value TP_{rcv2} measured from the second ACK interval, and thus the CPU 31 employs the estimated value TP_{tcp} of the TCP throughput as the effective throughput. That is, in this case, the approximated value TP_{rcv1} of the network bandwidth is smaller than the estimated value TP_{tcp} of the TCP throughput, and thus employing the approximated value TP_{rcv1} of the network bandwidth is not reasonable.

In this situation, the estimated value TP_{tcp} of the TCP throughput is employed as the effective throughput instead of employing the approximated value TP_{rcv1} of the network bandwidth as the effective throughput for the following reasons. That is, in this case, the expansion of the ACK interval is merely due to a cross traffic (disturbance), and the actual transfer time (0.9 msec) calculated according to formula (4) is shorter than RTT (2 msec) even in the low speed section, which means that there is an ineffective time in the network. Therefore, the approximated value TP_{rcv1} the network bandwidth is not suitable for the effective throughput in the low speed section, and thus the estimated value TP_{tcp} of the TCP throughput is employed as the effective throughput.

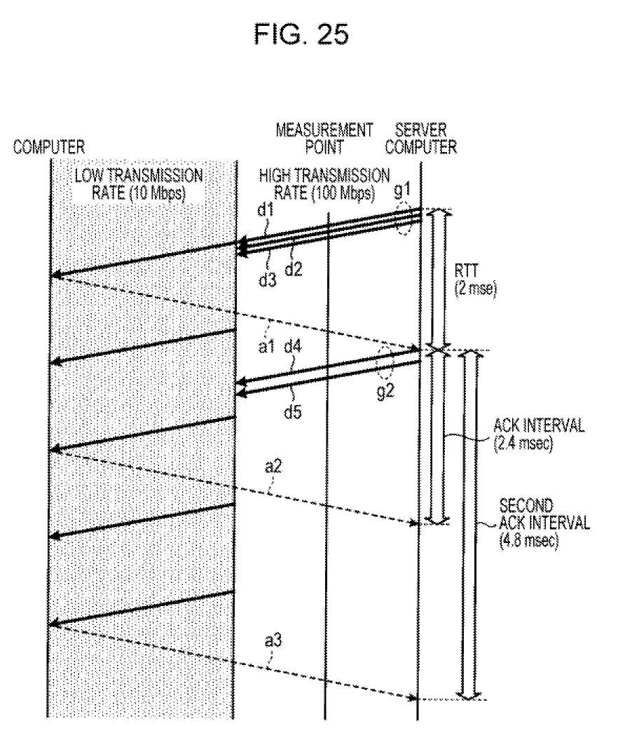

In FIG. 25, the number of pieces of DATA of a group g1 of DATA, the amount of data of each piece of DATA, RTT, the ACK interval, and the amount of data of DATA in the next group g2 are similar to those illustrated in FIG. 24. However, FIG. 25 is different from FIG. 24 in that the second ACK interval is 4.8 msec.

The CPU 31 substitutes RTT and cwind into formula (1), thereby calculating the estimated value TP_{tcp} of the TCP throughput. In this example, the estimated value TP_{tcp} of the TCP throughput is 18 [Mbps].

The CPU 31 calculates the approximated value TP_{rcv1} of the network bandwidth from the ACK interval and the amount of data of DATA excluding the first DATA in the group. In the example, the approximated value TP_{rcv1} of the network bandwidth is 10 [Mbps] as with the case illustrated in FIG. 24.

In this case, estimated value TP_{tcp} of the TCP throughput is greater than the approximated value TP_{rcv1} of the network bandwidth, and thus the CPU 31 determines that the employment of the estimated value TP_{tcp} of the TCP throughput is not reasonable, and thus CPU 31 determines the validity of the approximated value TP_{rcv1} of the network bandwidth as follows. The CPU 31 calculates the throughput value TP_{rcv2} measured from the second ACK interval, the second amount of packets, and the amount of data of DATA d4 and d5 in the next group g2. In the present example, the second ACK interval is 4.8 msec, the second amount of packets is 8×(2×1500 [bytes]) bits, and the amount of data of DATA d4 and d5 of the next group g2 is also 8×(2×1500 [bytes]) bits. The throughput value TP_{rcv2} is calculated as follows.

TP_{rcv2}=8×(4×1500[bytes])/4.8[msec]=10[Mbps] (8)

In this case, the estimated value TP_{tcp} of the TCP throughput is greater than the throughput value TP_{rcv2} measured from the second ACK interval, and thus the CPU 31 determines the approximated value TP_{rcv1} of the network bandwidth as the effective throughput. That is, in this case, employing the approximated value TP_{rcv1} of the network bandwidth is reasonable.

In this situation, the approximated value TP_{rcv1} the network bandwidth is employed as the effective throughput for the following reasons. That is, an expansion occurs also in the second ACK interval which is the ACK interval of the following packets, and thus it is estimated that the throughput in the low speed section is low. Besides, the actual transfer time to transfer DATA d1 to d3 is calculated as 3.6 msec according to formula (9), which is longer than RTT (2 msec), and thus there is no ineffective time in the network.

$$Actual transfer time = 8 \times ( 3 \times 1500 [ bytes ] ) \text{/} 10 [ Mbps ] = 3.6 [ msec ] \qquad ( 9 )$$

Therefore, the approximated value TP_{rcv1} of the network bandwidth is highly likely to be a suitable value as the effective throughput in the low speed section, and thus this value is regarded as the effective throughput.

The third embodiment has been described above. Other processes, elements, and the like similar to those in the first embodiment or the second embodiment are denoted by similar reference numerals or symbols, and a further description thereof is omitted.

### Fourth Embodiment

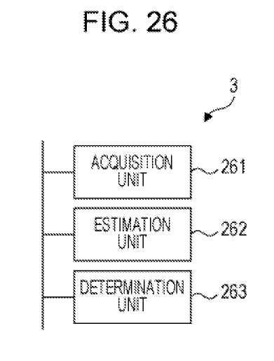

FIG. 26 is a functional block diagram illustrating an operation of the monitoring computer 3 according to an embodiment. By executing the control program 35P on the CPU 31, the monitoring computer 3 operates as follows. The acquisition unit 261 acquires time-series information on packets transmitted and received between the first apparatus and the second apparatus. The estimation unit 262 estimates the window size based on the acquired time-series information. Based on a temporal change in the estimated window size, the determination unit 263 determines a type of congestion control, from a plurality of congestion control candidates, which is being performed by the first apparatus.

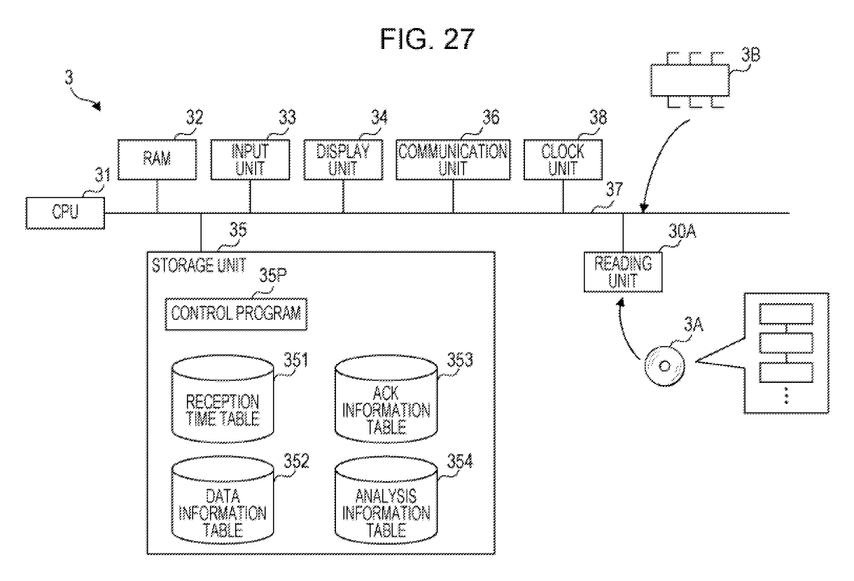

FIG. 27 is a block diagram illustrating a set of hardware of the monitoring computer 3 according to fourth embodiment. A program for operating the monitoring computer 3 may be stored in a portable storage medium 3A such as a CD-ROM, a DVD (Digital Versatile Disc) disk, a memory card, a USB (Universal Serial Bus) memory, or the like, and the program may be read out from the portable storage medium 3A via a reading unit 30A such as a disk drive, a memory card slot, or the like thereby loading the program in the storage unit 35. Alternatively, the program may be stored in a semiconductor memory 3B such as a flash memory, and the semiconductor memory 3B may be installed in the monitoring computer 3. Alternatively, the program may be downloaded from another sever computer (not illustrated) via a communication network N such as the Internet or the like. Details are further described below.

The monitoring computer 3 illustrated in FIG. 27 reads the program for executing the various software processes described above from the portable storage medium 3A or the semiconductor memory 3B, or monitoring computer 3 downloads the program from another sever computer (not illustrated) via the communication network N. This program installed as the control program 35P is loaded in the RAM 32 and executed.

The fourth embodiment has been described above. Other processes, elements, and the like similar to those in the first, second, or third embodiment are denoted by similar reference numerals or symbols, and a further description thereof is omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
acquiring time-series information that stores information on a packet transmitted and received between a first apparatus and a second apparatus, in association with a time at which the packet is transmitted or received;
estimating a window size indicating an amount of data that a receiver of the data is able to accept without acknowledging a sender of the data, based on the acquired time-series information; and
based on temporal change in the estimated window size, determining a type of congestion control being executed by the first apparatus, from among a plurality of candidate types of congestion control.

2. The non-transitory, computer-readable recording medium of claim 1, wherein the process further comprises:
calculating an amount of temporal change in the estimated window size;
extracting a maximum value of the calculated amounts of temporal change; and
in a case where the maximum value is not greater than a first threshold value, determining that congestion control being performed by the first apparatus belongs to a first type of congestion control that is used for a slow delay-based congestion control including: a slow loss-based control in which a congestion state is detected from a packet loss, and a slow delay-based control in which a congestion state is detected from a round trip time.

3. The non-transitory, computer-readable recording medium of claim 2, wherein the process further comprises:
estimating a round trip time, based on the acquired time-series information;
in a case where a packet loss occurs, determining whether a maximum value of the estimated round trip times is greater than the round trip time estimated before occurrence of the packet loss;
in a case where it is determined that the maximum value of the estimated round trip times is greater than the round trip time estimated before the occurrence of the packet loss, storing a first difference between the window sizes estimated before and after the occurrence of the packet loss, and storing a first number of times that it is determined that the maximum value of the estimated round trip times is greater than the round trip time estimated before the occurrence of the packet loss;
determining whether a sum of the first differences divided by the first number of times is greater than a second threshold value; and
in a case where it is determined that the sum of the first differences divided by the first number of times is greater than the second threshold value, determining that the congestion control being performed by the first apparatus belongs to a second type of congestion control that is used for a fast delay-based congestion control in which a congestion state is detected from a round trip time and congestion control is performed such that a whole bandwidth is effectively used even in a wideband network.

4. The non-transitory, computer-readable recording medium of claim 3, wherein the process further comprises:
in a case where a packet loss occurs, storing a second difference between the window sizes estimated before and after occurrence of the packet loss and storing a second number of times that the packet loss occurs;
determining whether a sum of the second differences divided by the second number of times is greater than a third threshold value; and
in a case where it is determined that the sum of the second differences divided by the second number of times is greater than the third threshold value, determining that the congestion control being performed by the first apparatus belongs to a third type of congestion control that is used for a fast loss-based congestion control in which a congestion state is detected from a packet loss and congestion control is performed such that a whole bandwidth is effectively used even in a wideband network.

5. The non-transitory, computer-readable recording medium of claim 4, wherein the process further comprises:
determining whether the sum of the second differences divided by the second number of times is greater than the third threshold value; and
in a case where it is determined that the sum of the second differences divided by the second number of times is not greater than the third threshold value, determining that the congestion control being performed by the first apparatus belongs to a fourth type of congestion control that is other than the first type, the second type, and the third type of congestion control.

6. The non-transitory, computer-readable recording medium of claim 5, wherein the process further comprises:
outputting cause information indicating a cause of a delay corresponding to each of the first type to the fourth type of congestion control.

7. The non-transitory, computer-readable recording medium of claim 2, wherein the process further comprises:
measuring a throughput for each of a plurality of connections;
in a case where it is determined in a time period that the congestion control being performed by the first apparatus is determined to belong to the first type of congestion control, determining whether there is a connection with a throughput higher than a predetermined threshold value in the time period; and
in a case where there is a connection with a throughput higher than the predetermined threshold value in the time period, outputting first cause information indicating that congestion control being performed by the first apparatus is highly likely to be a cause of delay.

8. The non-transitory, computer-readable recording medium of claim 4, wherein the process further comprises:
measuring a throughput for each of a plurality of connections;
in a case where it is determined, in a time period, that there is the second type of congestion control for one of the plurality of connections, determining whether there is a throughput higher than a predetermined threshold value among the throughputs measured in the time period and there is the second type of congestion control or the third type of congestion control for another connection, that; and
in a case where it is determined that there is a throughput higher than the predetermined threshold and there is the second type of congestion control or the third type of congestion control, outputting second cause information indicating that a mixture of the second type of congestion control and the third type of congestion control is highly likely to be a cause of delay.

9. The non-transitory, computer-readable recording medium of claim 4, wherein the process further comprises:
calculating a packet loss rate; and
in a case where it is determined that there is the third type of congestion control and the packet loss rate is greater than a predetermined threshold value, outputting third cause information indicating that delay is caused by the third type of congestion control and the packet loss rate.

10. The non-transitory, computer-readable recording medium of claim 3, wherein the process further comprises:
calculating a first round trip time by subtracting a time indicated by time information associated with a packet addressed to the second apparatus from a time indicated by time information associated with a packet addressed to the first apparatus;
calculating a second round trip time by subtracting a time indicated by time information associated with a packet addressed to the first apparatus from a time indicated by time information associated with a packet addressed to the second apparatus; and
calculating the round trip time that is estimated from a sum of the first round trip time and the second round trip time.

11. The non-transitory, computer-readable recording medium of claim 10, wherein the process further comprises:
calculating an end time, based on time information associated with a packet received from the first apparatus and the first round trip time; and
estimating the window size, based on the calculated end time, and time information and a sequence number of a packet that are acquired from the time-series information.

12. An apparatus comprising:
a processor configured to:
acquire time-series information that stores information on a packet transmitted and received between a first apparatus and a second apparatus, in association with a time at which the packet is transmitted or received,
estimate a window size indicating an amount of data that a receiver of the data is able to accept without acknowledging a sender of the data, based on the acquired time-series information, and
based on temporal change in the estimated window size, determine a type of congestion control being executed by the first apparatus, from among a plurality of candidate types of congestion control; and
a memory coupled to the processor and configured to store the time-series information.

13. A method comprising:
acquiring time-series information that stores information on a packet transmitted and received between a first apparatus and a second apparatus, in association with a time at which the packet is transmitted or received;
estimating a window size indicating an amount of data that a receiver of the data is able to accept without acknowledging a sender of the data, based on the acquired time-series information; and
based on temporal change in the estimated window size, determining a type of congestion control being executed by the first apparatus, from among a plurality of candidate types of congestion control.
